(19) United States
(12) Patent Application Publication
(10) Pub. No.: US 2007/0026285 A1
(43) Pub. Date: Feb. 1, 2007

(54) Proton conducting solid oxide electrolytes, electrochemical cells utilizing the proton conducting materials and methods of making the same

(76) Inventors: Da Yu Wang, Troy, MI (US); Walter T. Symons, Grand Blanc, MI (US); Robert Jerome Farhat, Grosse Pte. Park, MI (US); Elizabeth Marie Briggs, Chesterfield Twp., MI (US); Joachim Kupe, Davisburg, MI (US)

Correspondence Address: Paul L. Marshall;Delphi Technologies, Inc., M/C 480-410-202, P.O. Box 5052, Troy, MI, 48007, US

(21) Appl. No.: 11/192,221

(22) Filed: Jul. 28, 2005

(51) Int. Cl. H01M 8/12; C04B 35/64

(52) U.S. Cl. 429/33; 264/618

(57) ABSTRACT

Disclosed herein are electrochemical cells comprising a first electrode, a second electrode, and a solid oxide electrolyte disposed between and in ionic communication with the first electrode and the second electrode. The solid oxide electrolyte comprises the reaction product of a solid oxide electrolyte material, an aliovalent cation dopant, and a sintering aid selected from the group consisting of Al₂O₃, Ca₂Al₂O₅, and combinations comprising at least one of the foregoing. The electrochemical cells can be utilized water electrolyzers, hydrogen pumps and for various gas sensing cells, SOFCs, and the like.

### TECHNICAL FIELD

The present disclosure is related to proton conducting solid oxide electrolytes, electrochemical cells utilizing the same, and methods of making the same.

### BACKGROUND

Fuel cells are energy conversion devices that generate electricity and heat by electrochemically combining a gaseous fuel (such as hydrogen, carbon monoxide, hydrocarbons, and/or the like) with an oxidant (such as air, oxygen, and/or the like) across an ion-conducting electrolyte. The fuel cell converts chemical energy into electrical energy.

One type of fuel cell is a solid oxide fuel cell (SOFC), which utilizes an ion conductive oxide ceramic as the electrolyte. The voltage generated by individual SOFC cells is relatively small. Therefore, when higher voltages are desired, a plurality of individual cells can be electrically connected in series to form what is referred to as a “stack”.

There are many different types of electrolyte materials that can be used to form the electrolyte in SOFC devices, including proton conducting solid oxide electrolytes. Examples of proton conducting electrolytes comprise perovskite-type oxides such as SrCeO₃, BaCeO₃, CaZrO₃, SrZrO₃, BaZrO₃, non-perovskite-type oxides such as Ln₂Zr₂O₇, LaWO₃, LaPO₄, and proton conducting glass and glass ceramics. Proton-conducting solid oxide electrolytes can conduct protons when they are doped with aliovalent cations. The aliovalent cations create charge defects in the lattice of the oxide, to which protons can migrate and attach within the oxide lattices.

In hydrogen-technology applications, electrolyte materials can be subjected to a wide range of gas and temperatures. For example, the pressures within an operating SOFC can be about 0.01 kPa, to about 10 kPa or more; temperatures can be about −40° C. while not in use, to over 1,000° C. during use; and the chemical environment comprises both oxidizing and reductive conditions.

### SUMMARY

Disclosed herein in one embodiment is an electrochemical cell comprising a first electrode, a second electrode, and a solid oxide electrolyte disposed between and in ionic communication with the first electrode and the second electrode. The solid oxide electrolyte comprises the reaction product of a solid oxide electrolyte material, an aliovalent cation dopant, and a sintering aid selected from the group consisting of Al₂O₃, Ca₂Al₂O₅, and combinations comprising at least one of the foregoing.

In another embodiment, a method of making an electrochemical cell is disclosed. The method comprises forming a solid oxide electrolyte precursor by forming a mixture of a solid oxide electrolyte material, an aliovalent cation dopant, and a sintering aid selected from the group consisting of Al₂O₃, Ca₂Al₂O₅, and combinations comprising at least one of the foregoing. The solid oxide electrolyte precursor is heated at a temperature of greater than or equal to about 1,450° C. for less than or equal to about 2 hours to form a solid oxide electrolyte comprising about 95% of the maximum theoretical density of the solid oxide electrolyte. A first electrode and a second electrode are disposed in ionic communication with the solid oxide electrolyte.

In another embodiment, a solid oxide electrolyte is disclosed. The solid oxide electrolyte comprises a solid oxide electrolyte material, an aliovalent cation dopant, and a sintering aid selected from the group consisting of Al₂O₃, Ca₂Al₂O₅, and combinations comprising at least one of the foregoing. The solid oxide electrolyte comprises an electrical conductivity of greater than or equal to about 0.5° cS/cm at a temperature of about 900° C.

The above described and other features are exemplified by the following figures and detailed description.

### DRAWINGS

Refer now to the figures, which are exemplary embodiments, and wherein like elements are numbered alike.

FIG. 1 is an expanded isometric view of a portion of a stack of electrochemical SOFC, showing a complete cell and a portion of an adjacent cell.

FIG. 2 is a schematic of the operation of a SOFC.

FIG. 3 is a graphical representation of sample density at a function of sintering time for samples with and without a sintering aid.

FIG. 4 is a graphical representation of density as a function of alumina concentration after heating at about 1,450° C.

FIG. 5 is a graphical representation of density as a function of (CaO)₄(Al₂O₃)₂ sintering aid concentration after heating at about 1,450° C.

FIG. 6 is a graphical representation of sample density and conductivity as a function of dopant concentration.

FIG. 7 is a graphical representation of sample density and conductivity as a function of dopant concentration.

### DETAILED DESCRIPTION

At the outset of the description, it should be noted that the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. Unless defined otherwise, technical and scientific terms used herein have the same meaning as is commonly understood by one of skill in the art to which this invention belongs. The modifier “about” used in connection with a quantity is inclusive of the stated value and has the meaning dictated by the context (e.g., includes the degree of error associated with measurement of the particular quantity). The notation “+/−10%” means that the indicated measurement may be from an amount that is minus 10% to an amount that is plus 10% of the stated value. It is noted that the terms “bottom” and “top” are used herein, unless otherwise noted, merely for convenience of description, and are not limited to any one position or spatial orientation. Unless specified otherwise, the term “diameter” refers to the average diameter of a particle or agglomerate, as measured along its major axis.

Disclosed herein are proton conducting materials that are capable of being densified to about 95% of their maximum theoretical density (MTD) after heat treatment at temperatures of about 1,450° C. for a period of time of less than or equal to about two (2) hours. In contrast, other proton conducting solid oxide electrolyte materials may be capable of being densified up to about 95% of the MTD only after heat treatment for longer periods of time and at higher temperatures (e.g., up to about 10 hours at temperatures of about 1,600° C.). The present proton conducting materials are chemically stable, mechanically strong, and are capable of conducting protons at relatively high temperatures (e.g., about 800° C. to about 900° C.).

The present proton conducting materials can be used in a variety of electrochemical cells such as water electrolyzers (powder provided from outside source to dissociate water into H₂ and O₂), hydrogen pumps (supply power from outside to pump H₂ from one side of the electrode to the other side of electrode), and for various gas sensing cells, SOFCs, and the like.

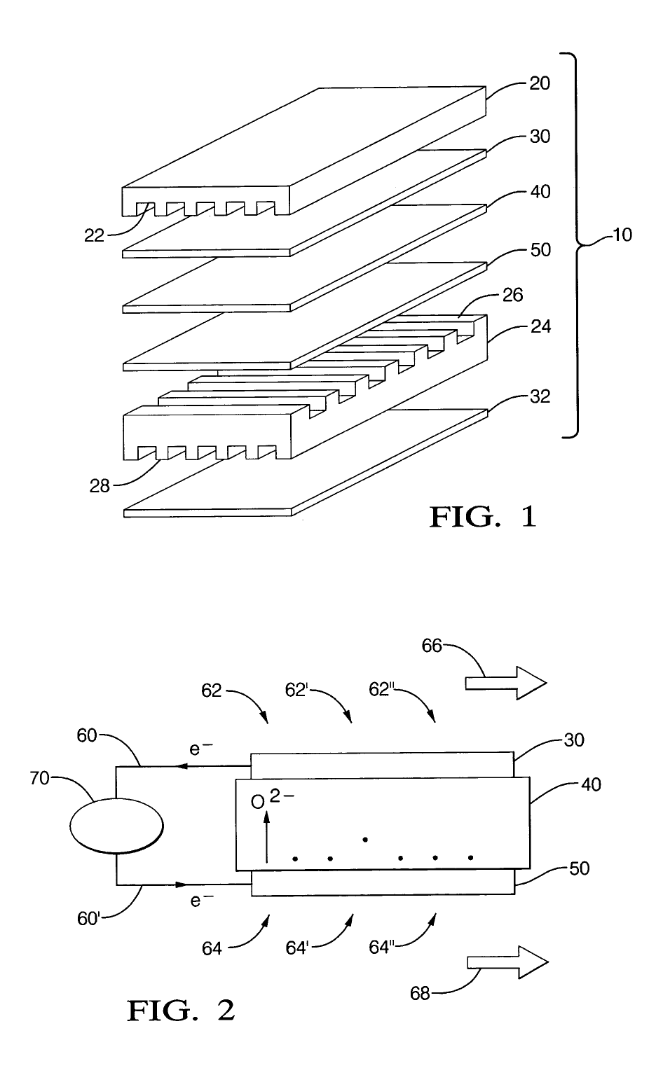

One configuration of a SOFC comprises a stack 10 of planar SOFCs 10a,b, as shown in FIG. 1. Cell 10a comprises an anode 30 (i.e. fuel electrode) and a cathode 50 (i.e. oxygen electrode) disposed on opposite sides of and in ionic communication with the solid electrolyte 40. The stack 10 comprises an end cap 20 and an interconnect 24 disposed opposite the end cap 20, and adjacent to an anode 32 from an adjacent cell 10b in the stack 10. Anode 32 is disposed adjacent to interconnect 24 to illustrate the placement of and ability to form the stack 10 by disposing several individual electrochemical cells adjacent to one another and in electrical communication with adjacent cells.

The end cap 20 comprises a surface 22 disposed adjacent to and in electrical communication with the anode 30. The surface 22 of the end cap 20 comprises a plurality of ribs 22a alternating with a plurality of channels 22b. The ribs 22a are configured to provide electrical communication between the end cap 20 and the anode 30, and the channels 22b are configured to distribute fuel to the anode 30.

Opposite the end cap 20, the stack 10 comprises an interconnect 24 disposed adjacent to and in electrical communication with the cathode 50. The interconnect 24 comprises a first interconnect surface 26 opposite a second interconnect surface 28. The first interconnect surface 26 can be disposed adjacent to the cathode 50, and the second interconnect surface 28 can be disposed adjacent to the anode 32 of the next electrochemical cell 10b in the stack 10.

The first surface 26 of the interconnect 24 comprises a plurality of ribs 26a alternating with a plurality of channels 26b. The ribs 22a are configured to provide electrical communication between the interconnect 24 and the cathode 50, and the channels 22b are configured to distribute oxidant to the cathode 50. The second surface 28 of the interconnect 24 comprises the same configuration as surface 22 of the end cap 20. Thus, the ribs 28a are configured to provide electrical communication between the interconnect 24 and the anode 32 of the adjacent cell in stack 10, and the channels 28b are configured to distribute fuel to the anode 32.

End cap 20 functions essentially the same way as does interconnect 24. For reasons of simplicity, end cap 20 and interconnect 24 are referred to hereinafter generically as flow plate 25, unless otherwise noted.

The electrolyte 40 of the electrochemical cell 10 can be capable of transporting oxygen ions from the cathode 50 to the anode 30, and/or capable of transporting protons from the anode 30 to cathode 50, as well as being compatible with and capable of withstanding the environment in which the SOFC will be utilized. As noted above, the electrolyte 40 can be subjected to a wide range of conditions. For example, the pressures within an operating SOFC can be about 0.01 kilopascal (kPa), to about 10 kPa or more; temperatures can be about −40° C. while not in use, to over 1,000° C. during use; and the chemical environment comprises both oxidizing and reductive conditions.

The solid oxide electrolyte 40 can comprise CaZr_{0.9}In_{0.1}O_{2.95}, CaZr_{0.95}In_{0.05}O_{2.975}, and/or the like, with a density of about 50 to about ninety-five percent (95%) of its MTD. For example, CaZr_{0.9}In_{0.1}O_{2.95} has an MTD of about 4.61 grams per cubic centimeter (g/cm³). Therefore, when the solid oxide electrolyte is CaZr_{0.9}In_{0.1}O_{2.95}, it can comprise a density of about 4.38 g/cm³, which is about 95% of its MTD.

The solid oxide electrolyte 40 can comprise a solid oxide material, an aliovalent cation dopant, and a sintering aid. The solid oxide material can be any solid oxide material capable of conducting protons when doped with an aliovalent cation, and that is capable of doing so under the conditions in which the SOFC will be operated. Possible solid oxide materials can comprise perovskite oxides (Me)(Me)(O₃), non-perovskite oxides, proton conducting glass, glass ceramics, and combinations comprising at least one of the foregoing. Examples of perovskite oxides include, but are not limited to, CaZrO₃, SrCeO₃, BaCeO₃, SrZrO₃, BaZrO₃, and/or the like. Examples of non-perovskite type oxides include, but are not limited to, Ln₂Zr₂O₇, LaWO₃, LaPO₄, and/or the like.

The aliovalent cation dopant can comprise any material capable of creating charge defects in the lattice of the solid oxide electrolyte material, and that is capable of doing so under the conditions in which the SOFC will be operated. Examples of aliovalent cation dopants comprise Gd⁺³, Ga⁺³, In⁺³, La⁺³, Sb⁺³, Sc⁺³, Sm⁺³, Y⁺³, Yb⁺³, and the like. Precursors to the aliovalent cation dopants can comprise oxides, nitrates, oxalates and/or carbonates of the aliovalent cation dopant, and the like.

The sintering aid can comprise any material capable of reducing the time and/or temperature at which the solid oxide electrolyte can be sintered, and that has no effect or minimal effect on the proton conductivity and electrical conductivity of the doped solid oxide material. Examples of sintering aids comprise alumina (Al₂O₃), (CaO)₄(Al₂O₃)₂, and/or the like, and combinations comprising at least one of the foregoing.

Formation of the solid oxide electrolyte 40 can comprise forming a mixture of the solid oxide material and the aliovalent cation dopant material precursor (hereinafter “dopant precursor”), both in powder form. The mixture of the solid oxide material and the dopant precursor can be mechanically mixed and then passively heated in air for about ten (10) hours at a temperature of about 1,000° C. During the heating step, the solid oxide material and the aliovalent cation dopant precursor react e.g., when CaCO₃, ZrO₂, and In₂O₃ are mixed together and heated as described, the CaCO₃ will react with the ZrO₂ and In₂O₃ to produce CO₂. The resulting mixture can then be combined with the sintering aid (e.g., (Al₂O₃), (CaO)₄(Al₂O₃)₂, and/or the like). The mixture comprising the sintering aid can be formed into a desired shape and then sintered to achieve the desired density. Alternatively, the mixture can be sintered first and then formed into a desired shape using various techniques such as, for example, machining.

The anode 30 and cathode 50 form phase boundaries with the electrolyte 40 and can be disposed adjacent to, or can be integral with the electrolyte 40. The anode 30 and cathode 50 can comprise a porous material that is capable of functioning as an electrical conductor, and that is capable of facilitating the appropriate reactions. The anodic and cathodic materials can comprise a sufficient porosity to enable dual directional flow of gases (e.g., to permit the inflow of the fuel or oxidant gases and to permit the outflow of the byproduct gases). For example, the anodic and cathodic materials can comprise a porosity of about 20% to about 40%.

The anode 30 and cathode 50 compositions can comprise elements including calcium, zirconium, yttrium, nickel, manganese, strontium, lanthanum, titanium, iron, cobalt, and/or the like, as well as oxides, alloys and combinations comprising at least one of the foregoing. The anode material can comprise a ceramic skeleton that is thermally compatible with the anode material as well as other materials in the stack 10, such as a yttria-stabilized zirconia skeleton.

The anode 30 and/or the cathode 50 can be disposed on the electrolyte 40 using various techniques including techniques such as sputtering, chemical vapor deposition, screen printing, spraying, dipping, painting, stenciling, and/or the like. The anodes and cathodes can comprise a thickness of greater than or equal to about 1,000 micrometers (μm) or, more specifically, a thickness of about 5 μm to about 50 μm.

The electrochemical cell 10a can be electrically connected with other electrochemical cells 10b by using, for example, the interconnect 24. Depending upon the geometry of the SOFC, the fuel flow to the anode or the oxidant flow to the cathode can be accomplished via the channels disposed in the flow plate 25. The flow plate 25 can comprise a material that is capable of withstanding the operating conditions of the SOFC, and that is capable of conducting electricity. For example, possible materials can comprise non-integral conductive wool, fibers (chopped, woven, non-woven, long, and the like), felt, mat, and/or the like. Flow plates can be formed from an electrically conductive material, which is compatible with the oxidizing or reducing nature of the fuel cell environment. Examples of flow plate materials can comprise, for example, silver, copper, ferrous materials, strontium, lanthanum, chromium, chrome, gold, platinum, palladium, nickel, titanium, conducting ceramics (e.g., doped rare earth oxides of chromium, manganese, cobalt, nickel, and the like; doped zirconia, including, zirconia doped with titanium, copper, and the like), and the like, as well as alloys, oxides, cermets, composites, and combinations comprising at least one of the foregoing materials. The design and construction of the flow plates can affect the efficiency and the operational parameters of the individual electrochemical cells, and also can be an important consideration in combining cells into a cell stack.

As noted above, each electrochemical cell 10a,b can generate a relatively small voltage, e.g., about 0.5 to about 1.2 volts. However, higher voltages are often required to make this power useful. These higher voltages are attained by electrically connecting a plurality of electrochemical cells in series to form a stack. The total number of cells forming a stack can range from 2 to several hundred, depending on power requirements, space and weight restrictions, economics, and the like. As stated above, cells are often connected through their end plates, making end plate design and construction an important factor in electrochemical cell efficiency.

It should be understood that many different types of SOFC systems exist, including tubular and planar systems. These various systems operate with different cell configurations. Therefore, reference to a particular cell configuration and components for use within a particular cell configuration are intended to also represent similar components in other cell configurations where applicable. The system may comprise at least one SOFC, an engine, at least one heat exchanger, and optionally, one or more compressors, an exhaust turbine, a catalytic converter, preheating device, plasmatron, electrical source (e.g., battery, capacitor, motor/generator, turbine, and the like, as well as combinations comprising at least one of the foregoing electrical sources), and connections, wiring, control valves, and a multiplicity of electrical loads, including, but not limited to, lights, resistive heaters, blowers, air conditioning compressors, starter motors, traction motors, computer systems, radio/stereo systems, and a multiplicity of sensors and actuators, and the like, as well as conventional components.

The dimensions of each cell may vary depending on the spatial requirements and the desired output. SOFCs may be employed in areas ranging from a microscopic scale, wherein each cell has an area of several micrometers squared (μm²), to an industrial power generation scale, such as in a power plant wherein each cell has an area of several meters squared (m²). Particularly useful dimensions for SOFCs employed in automotive applications are about 50 to about 200 square centimeters per cell (cm²/cell), but it will be understood that these dimensions may vary depending on various design considerations.

In operation, a single electrochemical cell 10a can produce a current flow as illustrated by current flow arrows 60, 60′ in FIG. 2. Hydrogen gases can be introduced to the anode side of the cell, flowing as illustrated by the oxidant flow arrows 62, 62′, 62″. The hydrogen produces the flowing electrons (e⁻), which converts hydrogen into protons as depicted in the following reaction:
H₂→2H⁺⁺²e⁻

Protons diffuse through the electrolyte 40 to the cathode 50. At the cathode, the protons react with oxygen, which is introduced to the electrochemical cell 10 as illustrated by the airflow arrows 62, 62′, 62″. The reaction of the proton and oxygen, receives electrons (e⁻), which flow from the anode 30, then outside of the electrochemical cell 10 to the external circuit 70 and back to the cathode 50. The fuel/oxygen ion reaction is depicted in the following reactions:
H₂+O⁻²→H₂O+2e⁻ (when fuel is hydrogen)
Unreacted oxygen and byproducts, such as water, exit the electrochemical cell 10 in the air stream, as illustrated by air stream arrow 68, while left over hydrogen exits the electrochemical cell 10, as illustrated by fuel arrow 66.

The electrolyte 40 can conduct the protons between the anode 30 and the cathode 50, maintaining an overall electrical charge balance. The cycle of flowing electrons (e⁻) from the anode 30 through the external circuit 70 to the cathode 50 creates electrical energy for harnessing. This electrical energy can be directly utilized by the vehicle to power various electrical parts, including, but not limited to, lights, resistive heaters, blowers, air conditioning compressors, starter motors, traction motors, computer systems, radio/stereo systems, and a multiplicity of sensors and actuators, among others. The electricity produced by the SOFC is direct current, which can be matched to the normal system voltage of the vehicle. This minimizes or avoids the need for devices such as diodes, voltage conversion and other losses, such as resistive losses in the wiring and in/out of the battery, associated with other vehicle systems and hybrid electrical systems. This high efficiency electricity allows electrification of the vehicle, including functions such as air conditioning and others, while allowing reduced weight, improved fuel economy and improved performance advantages compared to other hybrid electric mechanization and internal combustion engine systems.

During start-up, and for cabin heating, the SOFC can be operated at high adiabatic temperatures, e.g. up to about 1,000° C., subject to catalyst limitations, with operating temperatures of greater than or equal to about 600° C. to about 900° C., more specifically greater than or equal to about 650° C. to about 800° C. Consequently, at least one heat exchanger can be employed to cool the SOFC effluent and conversely heat the air prior to entering the SOFC, with conventional heat exchangers employed.

To facilitate the production of electricity by the SOFC, a direct supply of simple fuel (e.g., hydrogen,) can be used. However, concentrated supplies of these fuels can be expensive and difficult to supply. Therefore, the fuel utilized can be obtained by processing a more complex fuel source. The actual fuel utilized in the system can be selected based upon the application, expense, availability, and environmental issues relating to the fuel. Possible fuels can include, but are not limited to, hydrocarbon fuels, including, but not limited to, liquid fuels, such as gasoline, diesel, ethanol, methanol, kerosene, and others; gaseous fuels, such as natural gas, propane, butane, and others; and “alternative” fuels, such as hydrogen, biofuels, dimethyl ether, and others; synthetic fuels, such as synthetic fuels produced from methane, methanol, coal gasification or natural gas conversion to liquids, and combinations comprising at least one of the foregoing methods, and the like; as well as combinations comprising at least one of the foregoing fuels. The type of fuel employed can vary depending upon the type of engine employed. Lighter fuels (i.e., those which can be more readily vaporized), and/or fuels are readily available to consumers.

The SOFC may be used in conjunction with an engine, for example, to produce tractive power for a vehicle. Within the engine, SOFC effluent, air, and/or fuel are burned to produce energy, while the remainder of unburned fuel and reformed fuel is used as fuel in the SOFC. The engine can be any combustion engine including, but not limited to, internal combustion engines such as spark ignited and compression ignited engines, including, but not limited to, variable compression engines.

The following non-limiting examples further illustrate the various embodiments described herein.

### WORKING EXAMPLES

### Example 1

A comparison was made of the density of a solid oxide doped with aliovalent cations with and without an alumina sintering aid. Powders of CaCO₃, ZrO₂, and In₂O₃ (44.979 grams each) having particle diameters of about 45 μm (sieved with 325 mesh sieve) were mixed with a mortar and pestle by hand for about 15 minutes, and then calcined by passively heating in air for about ten (10) hours at a temperature of about 1,000° C. The resulting calcined powder mixture had the formula CaZr_{0.9}In_{0.1}O_{2.95}. Alumina was added to a portion of the resulting CaZr_{0.9}In_{0.1}O_{2.95} calcined powder mixture to achieve a concentration of about 0.7 wt. % of alumina in the CaZr_{0.9}In_{0.1}O_{2.95}, based on the starting weight of CaZr_{0.9}In_{0.1}O_{2.95}. Pellets of the calcined powder mixture (with and without the sintering aid) were formed by pressing uniaxially at a pressure of 20,000 pounds per square inch (psi). Some pellets from each group were sintered at a temperature of about 1,450° C. for about two (2) hours, and others were sintered at a temperature of about 1,450° C. for about twenty-five (25) hours. The density of the pellets from each group was measured by displacement at various intervals.

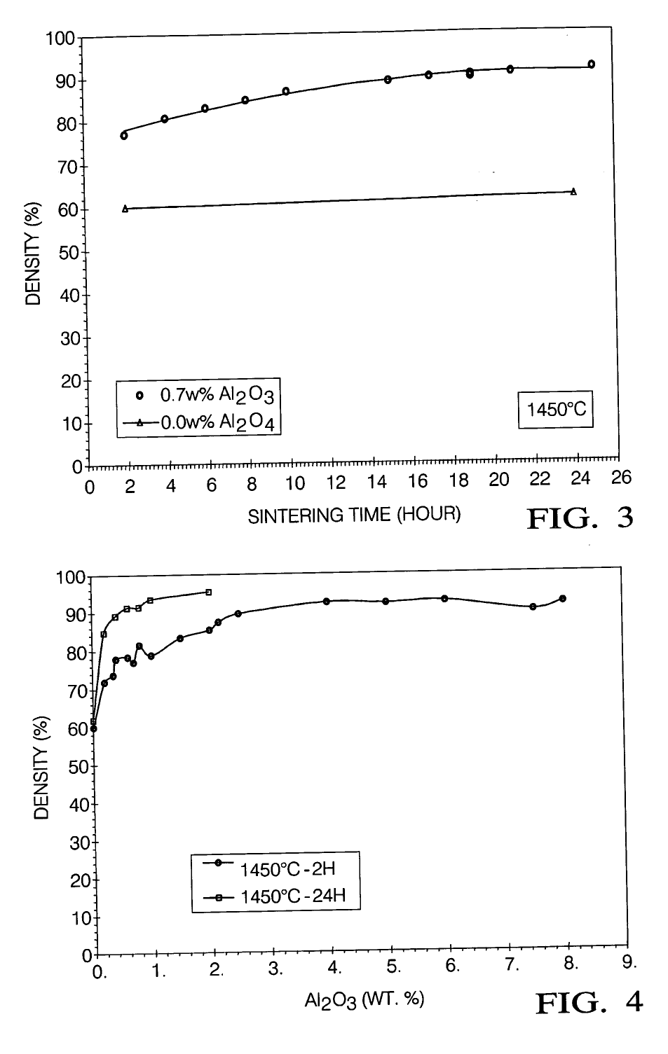

FIG. 3 shows the results of density measurements of the pellets. As shown, the pellets without the alumina sintering aid reached an MTD of about 60%, even after sintering for up to twenty-five (25) hours. In addition, increasing the sintering time had a negligible effect on the densification.

In contrast, substantially higher densification was attained in the pellets with the alumina sintering aid after only about two (2) hours (e.g., about a 15% increase in densification over samples without alumina). As shown in the graph, higher densification levels were attained by increasing the sintering time (e.g., about 85% of the MTD after about 8 hours; about 90% of the MTD after about 18 hours; and greater than about 90% of the MTD after about 25 hours).

### Example 2

The same processes used in Example 1 were used to form various concentrations of alumina sintering aid in a solid oxide electrolyte (i.e. 0.2 wt. %; 0.35 wt. %; 0.4 wt. %; 0.6 wt. %; 0.7 wt. %; 0.8 wt. %; 1.0 wt. %; 1.5 wt. %; 2.0 wt. %; 2.15 wt. %; 2.5 wt. %; 4.0 wt. %; 5.0 wt. %; 6.0 wt. %; 7.5 wt. %; 8.0 wt. % alumina in CaZr_{0.9}In_{0.1}O_{2.95}, based on the starting weight of CaZr_{0.9}In_{0.1}O_{2.95}). The density of the pellets from each group was measured using the Archimedes method.

FIG. 4 shows the results of density measurements of the pellets. As shown, greater than about 85% of the MTD was attained in samples having concentrations of greater than or equal to about 0.4 wt. % of alumina sintering aid after sintering for about two (2) hours at about 1,450° C. At lower concentrations, comparable densities were achieved, but only after the extended sintering period (i.e. 24 hours). This shows the effectiveness of increasing the alumina sintering aid concentration at reducing the sintering time, while attaining relatively high MTDs i.e., greater than 80%.

### Example 3

The same processes used in Example 1 were used to form various concentrations of (CaO)₄(Al₂O₃)₂ sintering aid in a solid oxide electrolyte (i.e. 0.2 wt. %; 0.35 wt. %; 0.4 wt. %; 0.6 wt. %; 0.7 wt. %; 0.8 wt. %; 1.0 wt. %; 1.5 wt. %; 2.0 wt. %; 2.15 wt. %; 2.5 wt. %; 4.0 wt. %; 5.0 wt. %; 6.0 wt. %; 7.5 wt. %; 8.0 wt. % alumina in CaZr_{0.9}In_{0.1}O_{2.95}, based on the starting weight of CaZr_{0.9}In_{0.1}O_{2.95}). The density of the pellets from each group was measured using the Archimedes method.

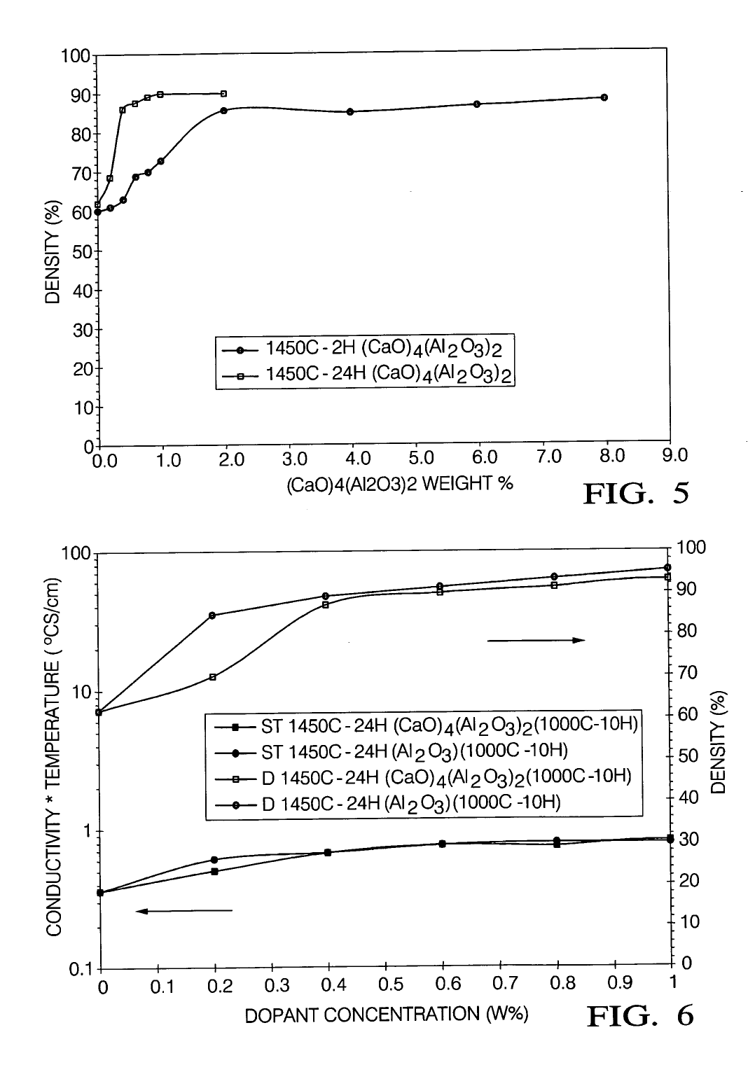

FIG. 5 shows the results of density measurements. As shown, greater than about 80% of the MTD was attained in samples having concentrations of greater than or equal to about 2.0 wt. % of (CaO)₄(Al₂O₃)₂ sintering aid after sintering for about two (2) hours at about 1,450° C. At lower concentrations, comparable densities were achieved, but only after the extended sintering period (i.e. 24 hours). This shows that increasing the (CaO)₄(Al₂O₃)₂ sintering aid concentration is effective at reducing the sintering time, while attaining relatively high densification levels i.e., greater than or equal to about 80% of the MTD.

### Example 4

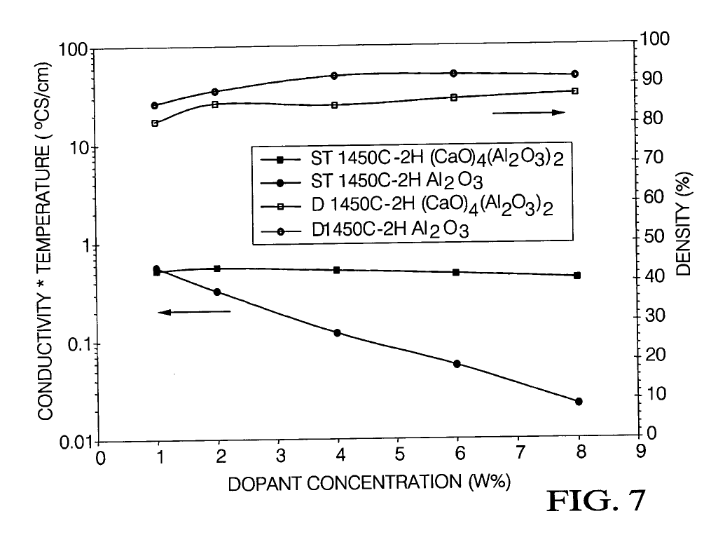

Samples from Examples 2 and 3 having sintering aid concentrations of 1 wt. % or less were selected and sintered for about twenty-four (24) hours at about 1,450° C. The 900° C. air conductivity and room temperature density of the samples was then measured. As shown in FIG. 6, at concentrations 1 wt. % or less of either the alumina or (CaO)₄(Al₂O₃)₂ sintering aids, the conductivity of the material was stable. As shown in FIG. 7, at concentrations of greater than 1 wt. % of alumina sintering aid, the conductivity values began to decrease.

The present solid oxide electrolytes: 1) can be densified at substantially lower temperatures and/or for shorter periods of time in comparison to other proton conducting solid oxide electrolytes (e.g., in order to attain about 90% MTD, the present solid oxide electrolytes containing the sintering aids described above can be sintered for about 2 hours at about 1400° C., whereas materials without the sintering aids require about 24 hours at about 1600° C.; 3) can comprise similar mechanical strength, electrical conductivity, and thermal conductivity as other proton conducting solid oxide electrolytes.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An electrochemical cell, comprising:
a first electrode;
a second electrode; and
a solid oxide electrolyte disposed between and in ionic communication with the first electrode and the second electrode, the solid oxide electrolyte comprising the reaction product of a solid oxide electrolyte material, an aliovalent cation dopant, and a sintering aid selected from the group consisting of Al₂O₃, Ca₂Al₂O₅, and combinations comprising at least one of the foregoing.

2. The electrochemical cell of claim 1, wherein the solid oxide electrolyte comprises a sintering aid concentration of greater than or equal to about 0.1 wt. % to about 10 wt. %, based on the total weight of the solid oxide electrolyte.

3. The electrochemical cell of claim 1, wherein the solid oxide electrolyte comprises a density of about 95% of the maximum theoretical density of the solid oxide electrolyte.

4. The electrochemical cell of claim 1, wherein the solid oxide electrolyte material comprises perovskite oxides, non-perovskite oxides, proton conducting glass, glass ceramics, and combinations comprising at least one of the foregoing.

5. The electrochemical cell of claim 1, wherein the solid oxide electrolyte material comprises CaZrO₃.

6. The electrochemical cell of claim 1, wherein the aliovalent cation dopant is selected from the group consisting of Gd⁺³, Ga⁺³, In⁺³, La⁺³, Sb⁺³, Sc⁺³, Sm⁺³, Y⁺³, Yb⁺³, and combinations comprising at least one of the foregoing.

7. The electrochemical cell of claim 1, wherein the solid oxide electrolyte comprises an electrical conductivity of greater than or equal to about 0.5° cS/cm at about 900° C.

8. A method of making an electrochemical cell, comprising:
forming a solid oxide electrolyte precursor by forming a mixture of a solid oxide electrolyte material, an aliovalent cation dopant, and a sintering aid selected from the group consisting of Al₂O₃, Ca₂Al₂O₅, and combinations comprising at least one of the foregoing;
heat treating the solid oxide electrolyte precursor at a temperature of greater than or equal to about 1,450° C. for less than or equal to about 2 hours to form a solid oxide electrolyte comprising about 95% of the maximum theoretical density of the solid oxide electrolyte; and
disposing a first electrode and a second electrode in ionic communication with the solid oxide electrolyte.

9. The method of claim 7, wherein the solid oxide electrolyte comprises a sintering aid concentration of greater than or equal to about 0.1 wt. % to about 10 wt. %, based on the total weight of the solid oxide electrolyte.

10. The method of claim 7, wherein the solid oxide electrolyte comprises an electrical conductivity of greater than or equal to about 0.5° cS/cm at a temperature of about 900° C.

11. A solid oxide electrolyte, comprising:
a solid oxide electrolyte material;
an aliovalent cation dopant; and
a sintering aid selected from the group consisting of Al₂O₃, Ca₂Al₂O₅, and combinations comprising at least one of the foregoing;
wherein the solid oxide electrolyte comprises an electrical conductivity of greater than or equal to about 0.5° cS/cm at a temperature of about 900° C.

12. The solid oxide electrolyte of claim 11, comprising a sintering aid concentration of about 0.1 wt % to about 1.0 wt. %, based on the total weight of the solid oxide electrolyte.

13. The solid oxide electrolyte of claim 11, comprising a density of about 95% of the maximum theoretical density of the solid oxide electrolyte.
